(19) United States
(12) Patent Application Publication
(10) Pub. No.: US 2010/0021874 A1
(43) Pub. Date: Jan. 28, 2010

(54) Inculcating Positive Altered Personal Behavioral Patterns

(76) Inventor: John Milford Cunningham, Weed, CA (US)

Correspondence Address: Ashok Tankha, 36 Greenleigh Drive, Sewell, NJ, 08080, US

(21) Appl. No.: 12/178,648

(22) Filed: Jul. 24, 2008

(51) Int. Cl. G09B 19/00

(52) U.S. Cl. 434/238

(57) ABSTRACT

Disclosed herein is a method of inculcating positive altered personal behavioral patterns in a participant. The participant creates a resource inventory of items that induce a state of well being in the participant. The items may comprise people, spiritual deities, events, places, animals, objects, etc. The participant is led through bilateral stimulation processes by an instructor. Bilateral stimulation of the participant's conscious and unconscious memory networks associated with the items of the resource inventory enables the participant to activate a positive mental state. The instructor then reinforces the positive mental state of the participant. Performance enhancement protocols are applied on the participant in the reinforced positive mental state. Self enhancement exercises invoke positive conditioned responses of the participant. By reinforcing the positive conditioned responses, positive altered personal behavior patterns are inculcated in the participant.

### BACKGROUND

This invention, in general, relates to discovering repressed emotions and cognitions of self worth of a participant and more specifically, relates to inculcating positive altered personal behavioral patterns of the participant based on the discovered emotions and cognitions of self worth.

The human brain is made up of the conscious mind and the unconscious mind. While it is relatively easy for humans to access the conscious mind, most humans barely fathom the presence of the unconscious mind, much less being able to access the unconscious mind. The unconscious or subconscious mind, according to classical Freudian psychoanalysis, is a “part” of the mind that stores repressed memories. The theory of repression maintains that some experiences are too painful to be reminded of, so the brain moves the memories of the experiences to the unconscious or the subconscious. Certain positive memories are also pushed into the subconscious as a result of social, situational, developmental, and medical influences on the participant over time.

Although it might seem, on the surface, that people's lives are structured simply by conscious thought and speech, people are significantly influenced by the gap between the symbolic and the real or, in other words, by what is missing from their lives simply because they filter all their experiences based on social dependencies, external events, and circumstantial situations. Human beings are born with an innate tendency for happiness and joy. As one of the creations of the universe every individual is created to be worthwhile and have value, which cannot be taken away, but can only be belittled by negative experiences through life. The characteristics of self worth are intentionally or unintentionally pushed into the unconscious or the subconscious over time. Therapies used by psychologists today to help a patient discover the characteristics of self worth generally require months or even years to produce significant results.

Hence, there is an unmet need for a method of enabling a patient to discover self worth in a short span of time and to use the discovered self worth to alter personal behavioral patterns leading to a more fulfilling life.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method disclosed herein addresses the above stated need for enabling a participant to alter personal behavioral patterns in a short span of time. The participant creates an item resource inventory of items that induce a state of well being in the participant. The items may comprise people, events, places, spiritual deities, animals, objects, etc. An instructor then leads the participant through a bilateral stimulation process. Bilateral stimulation comprises applying one or more stimuli to the participant. Spatial position of the applied stimuli changes in a predetermined manner. For example, the spatial position of the applied stimuli may change alternately between the left body portion and the right body portion of the participant. The change in the spatial position of the applied stimuli activates the left cerebral hemisphere and the right cerebral hemisphere of the participant.

The applied stimuli may be one or more of auditory stimuli, tactile stimuli, and visual stimuli. Further, bilateral stimulation may also involve physical activity where the participant uses the left body portion and the right body portion alternately. The bilateral stimulation process activates a positive mental state in the participant through a bilateral stimulation of conscious and unconscious memory networks associated with the items of the resource inventory. The conscious and unconscious memory networks store psychosomatic information comprising one or more of thoughts, images, audio, olfactory memories, emotions, and somatic sensations of the participant.

The participant is then guided through different exercises to identify past events where the participant has experienced a state of success. Each of the successful past events is coupled with bilateral stimulation to reveal an enhanced understanding of personal attributes and talents and to induce a positive mental state in the participant. The enhanced understanding of personal attributes and talents of the participant enhances the confidence and motivation of the participant. The participant may record successful past events, psychosomatic information associated with the successful past events, and associated positive cognitive beliefs in an event resource inventory.

The instructor then reinforces the positive mental state of the participant through the bilateral stimulation. When a participant identifies people, events, places, animals, spiritual deities, etc. having a personal meaning to the participant, the participant begins to connect and create an association among the identified items, thereby leading to personal clarity, knowledge of life, and increased self-assurance and motivation to achieve the life purpose of the participant. The instructor then applies performance enhancement protocols on the participant to reinforce the positive mental state. The performance enhancement protocols are developed to identify a vitalized sense of life purpose, confidence, and motivation with newly recognized possibilities based on the items of the resource inventory and the successful past events.

The performance enhancement protocols invoke new positive conditioned responses of the participant through self enhancement exercises and use of the bilateral stimulation. The new positive conditioned responses allow the participant to dissociate oneself from old dysfunctional or counter productive behaviors, personal fears and non conducive life patterns. The new positive conditioned responses based upon the resource inventory and the successful past events allow a positive outlook on situations, greater choice, and creativity in problem solving and innovation without intrusion of the old dysfunctional or counter productive behaviors, the personal fears, and the non conducive life patterns. The positive outlook increases the level of personal satisfaction, self-esteem, resiliency, and enhances performance and productivity of the participant. By reinforcing the positive conditioned responses of the participant, positive altered personal behavior patterns are inculcated in the participant.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of inculcating positive altered personal behavioral patterns in a participant.

FIG. 2 exemplarily illustrates a system for bilateral stimulation of a participant.

FIG. 3 exemplarily illustrates an item resource inventory worksheet for listing items, psychosomatic information associated with the items, and positive cognitive beliefs associated with each of the items.

FIG. 4 exemplarily illustrates a worksheet comprising a predefined graphical image, and a provision to summarize past successful events and associated positive cognitive beliefs of the participant.

FIG. 5 exemplarily illustrates an event resource inventory worksheet for listing successful past events of the participant, psychosomatic information associated with the successful past events, and positive cognitive beliefs associated with the successful past events.

FIG. 6 exemplarily illustrates test results obtained by applying a process of inculcating positive altered personal behavioral patterns through bilateral stimulation and performance enhancement protocols on a group of participants.

FIG. 7 exemplarily illustrates test results obtained by applying a process of inculcating positive altered personal behavioral patterns through bilateral stimulation combined with performance enhancement protocols on a group of participants.

FIG. 8 exemplarily illustrates test results obtained by applying a process of inculcating positive altered personal behavioral patterns through bilateral stimulation combined with performance enhancement protocols on a group of participants incorporating work experience of the participants.

FIGS. 9A-9B exemplarily illustrates a process of implementing bilateral stimulation combined with performance enhancement protocols on a participant.

### DETAILED DESCRIPTION OF THE INVENTION

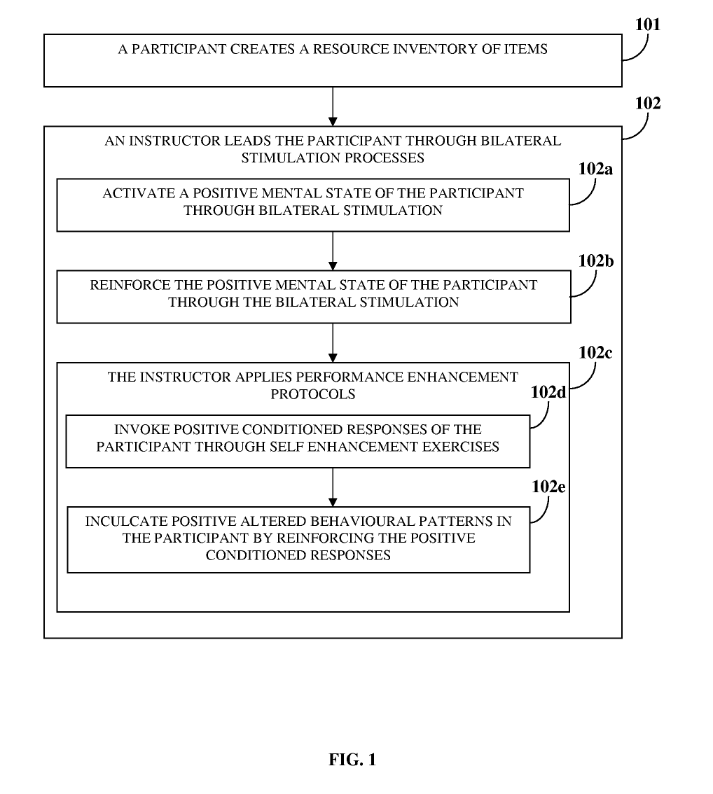

FIG. 1 illustrates a method of inculcating positive altered personal behavioral patterns in a participant. For the purposes of illustration, the detailed description of the invention refers to a single participant; however the scope of the invention is not limited to a single participant and may comprise multiple participants in a group environment. The participant creates 101 an item resource inventory of items associated with the participant. The items in the item resource inventory created by the participant comprise items inducing a sense of well being in the participant. The items may comprise people, spiritual deities, events, places, animals, objects, etc. The participant may choose famous people in history, mythical entities, pets, nature, etc. to include in the resource inventory. The item resource inventory created by the participant is the combined totality of conscious and unconscious memory networks associated with the specific items of the resource inventory. The conscious and unconscious memory networks are neurological memory networks that store psychosomatic information comprising thoughts, images, audio, olfactory memories, emotions, and somatic sensations of the participant associated with the items of the resource inventory.

After the participant has created the item resource inventory, an instructor leads 102 the participant through a bilateral stimulation process for each identified item in the item resource inventory. Bilateral stimulation comprises one or more activities that result in neurological transfer of information between the left hemisphere and the right hemisphere of the brain. Bilateral stimulation comprises applying one or more stimuli to the participant. Spatial position of the applied stimuli changes in a predetermined manner. For example, the spatial position of the applied stimuli may change alternately between the left body portion and the right body portion of the participant. The change in the spatial position of the applied stimuli activates the left cerebral hemisphere and the right cerebral hemisphere of the participant alternately. The applied stimuli may be one or more of auditory stimuli, tactile stimuli, and visual stimuli. Further, bilateral stimulation may also involve physical activity where the participant uses the left body portion and the right body portion alternately. Typically the physical activities include walking, running, rocking, jumping, etc. In clinical settings, bilateral stimulation may be administered through alternate tapping of the left portions and the right portions of the body, moving the eyes left and right, or panning sounds from left to right ear using a headset.

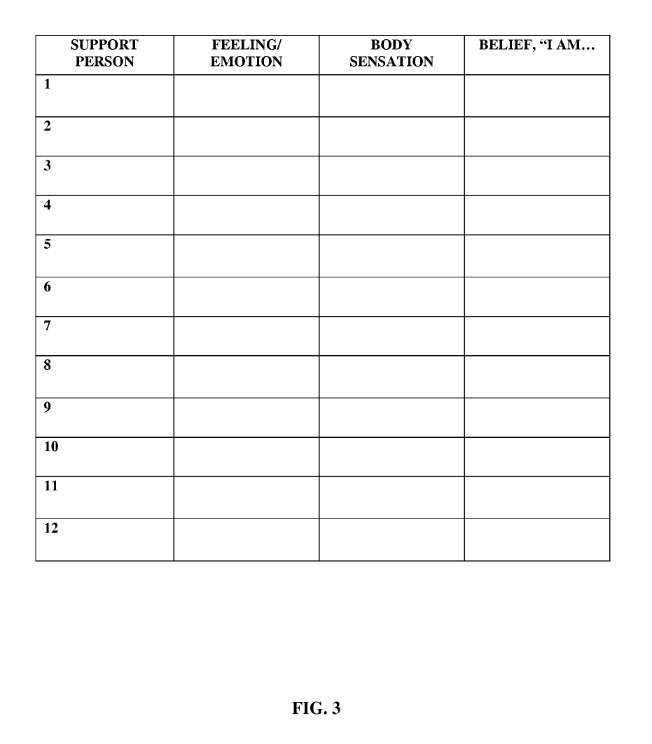

The bilateral stimulation processes tap the conscious and unconscious memory networks of the participant associated with each item in the item resource inventory and activates 102a a positive mental state in the participant. The conscious and unconscious memory networks store psychosomatic information comprising one or more of thoughts, images, audio, olfactory memories, emotions, and somatic sensations of the participant. The instructor instructs the participant to focus attention on each of the items of the item resource inventory one at a time and to record the feelings, emotions, and somatic sensations associated with each of the items in the item resource inventory illustrated in FIG. 3. The instructor applies bilateral stimulation on the participant simultaneously while the participant maintains attention on each of the items. During the bilateral stimulation of the participant in the focused state of attention, the participant experiences an increased congruency among emotions, imagery of the items, somatic sensations, along with a positive cognitive beliefs associated with each item. The bilateral stimulation process reinforces 102b the positive mental state in the participant. The bilateral stimulation process helps the participant to identify a vitalized sense of life purpose, self confidence, self-esteem, resiliency, and motivation based on items of the item resource inventory. Subjecting the participant to bilateral stimulation while the participant focuses attention on the items of the item resource inventory, results in a synthesis of seemingly divergent and unrelated ideas and aspects of experiences into a single focused understanding of the life purpose, necessary purposes in life, level of motivation, hidden abilities, personal self-esteem, resilience, and performance. Further subjecting the participant to bilateral stimulation during the focused state of attention enables the participant to alter personal behavioral patterns in a reduced time span.

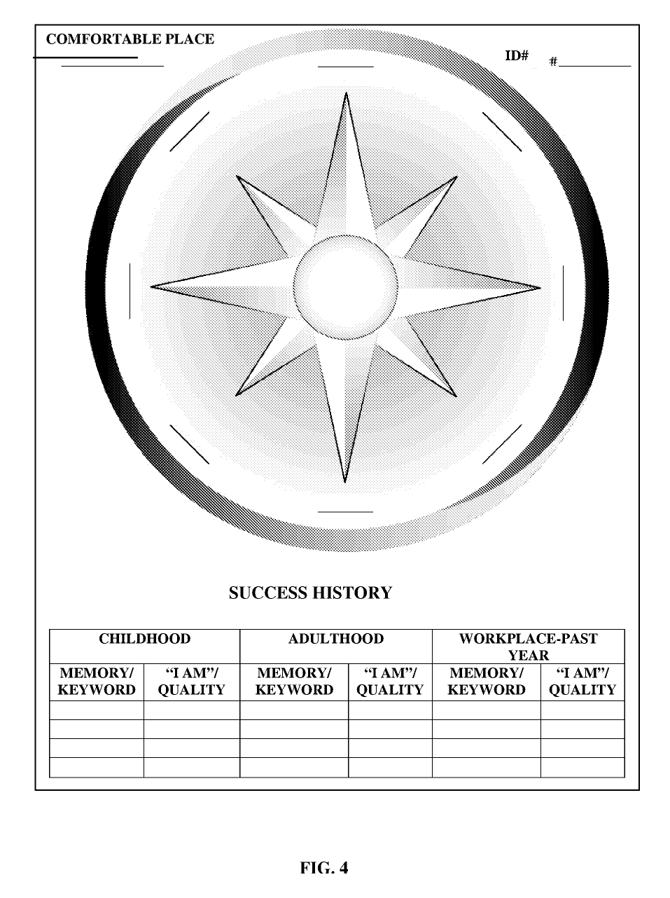

After the participant is led through the bilateral stimulation process, the participant spontaneously associates positive cognitive beliefs with each item in the item resource inventory. The participant may associate a positive cognitive belief, for example, “I am capable”, corresponding to a particular task listed among the items. The participant arranges each of the items of the item resource inventory along with the associated positive cognitive beliefs on a predefined geometrical image. The predefined geometrical image may be a compass as illustrated in FIG. 4. The participant arranges the items and the positive cognitive beliefs on the geometrical image in a spatial pattern determined by the participant. The participant may be influenced to create a relational structure among the items to be arranged by visual attributes of the geometrical image, such as shape, size, color, symmetry, etc. The relational structure may be dependent on the conscious cognitive states or unconscious cognitive states of the participant. For example, the participant may arrange the most significant items of the item resource inventory along the more visually distinctive locations of the geometrical image. The distinctive locations may comprise a different color from the remaining portions of the geometrical image or may comprise a difference in size from the remaining portions of the geometrical image.

On arranging the items and the associated positive cognitive beliefs on the geometrical image, bilateral stimulation is applied to the participant. Simultaneously, the instructor instructs the participant to visually scan the geometrical image and observe the different relations that the participant creates consciously or subconsciously among the items. The participant experiences a combined positive memory network of all the items in the resource inventory. The conscious and unconscious memory networks are augmented by the bilateral stimulation, whereby the participant activates a positive mental state by referencing the geometrical image visually or mentally.

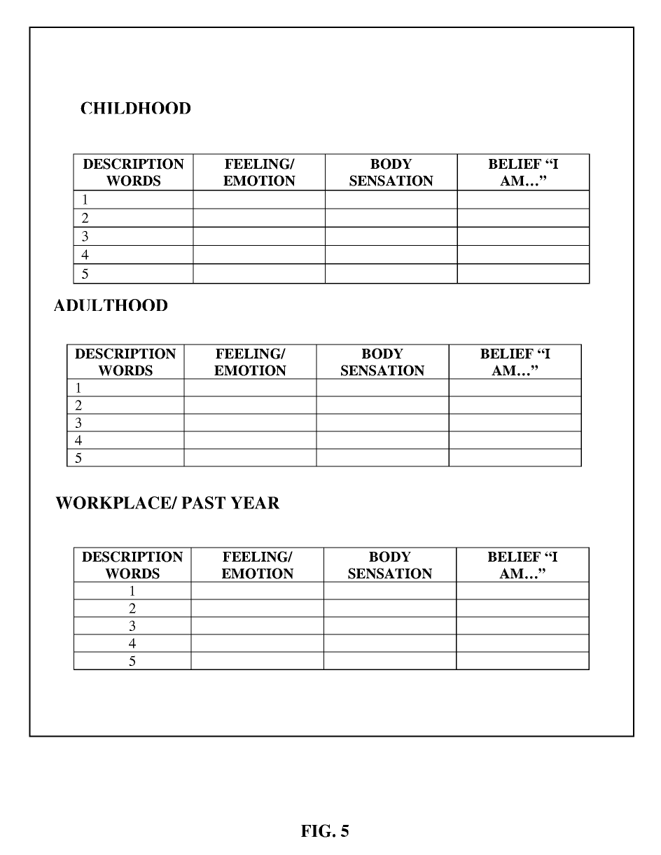

The instructor then instructs the participant to identify and create an event resource inventory by listing past events where the participant experienced a state of success. The participant makes a list of the successful past events by categorizing the successful past events through childhood, adulthood, the previous year, at the workplace, etc. The participant records successful past events, psychosomatic information associated with the successful past events, and positive cognitive beliefs associated with the successful past events in an event resource inventory worksheet illustrated in FIG. 5. The bilateral stimulation process individually activates the conscious and unconscious memory networks associated with the successful past events. Bilateral stimulation facilitates a deeper and clearer recognition of the memory networks along with bringing the mind, body, emotions, and spirit into congruent alignment and agreement. The instructor then instructs the participant under the influence of bilateral stimulation, to imagine the successful past events and to record psychosomatic information and positive cognitive beliefs associated with each of the successful past events derived as a result of the participant's focus on the items in the resource inventory during the bilateral stimulation.

The participant arranges each of the successful past events in the event resource inventory along with the associated positive cognitive beliefs on the predefined geometrical image. The instructor leads the participant through another bilateral stimulation process and simultaneously instructs the participant to visually scan the geometrical image and observe the different relations that the participant creates consciously or subconsciously amongst the successful past events. The participant experiences a rapid synthesis of the positive attributes combined with an integrated knowledge of the unique talents of the participant evident from the successes recognized by the participant. The synthesis of the new found image of self and self esteem allows for a new foundation to approach all aspects of life including relationships, goals, challenges, creativity, leadership, and innovation.

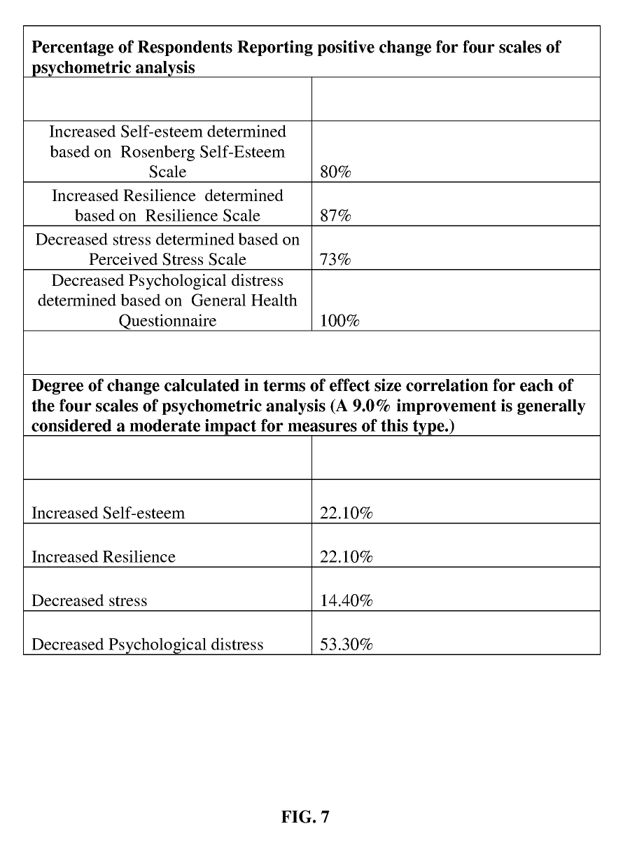

Coupling each of the items in the resource inventory and the successful past events with bilateral stimulation reveals an enhanced understanding of the personal talents to the participant. The ability of the participant to access the talents by recalling the image associated with the items or successful past events infuses a positive mental state of the participant. The positive mental state of the participant enhances the self confidence, self-esteem, resiliency, and motivation of the participant while decreasing stress and psychological distress as illustrated in FIG. 7.

FIG. 4 exemplarily illustrates a worksheet comprising a predefined graphical image such as a compass, and a provision to summarize past successful events and associated positive cognitive beliefs of the participant. The compass may be well understood by the participant and may symbolize the participant's personal life map. The participant may view the compass as a symbol of self. The instructor may then lead the participant through the bilateral stimulation process. During the bilateral stimulation process the participant may be encouraged to arrange the items and the successful past events from the resource inventory on the compass. The participant may then be encouraged to be creative with the positioning of the items and the successful past events and the associated positive cognitive beliefs on the compass. The participant may then rationally correlate the items and the successful past events on the compass. The instructor may then apply the bilateral stimulation on the participant and the participant may be asked to allow the participant's eyes to move around the compass and notice the emotions, body sensations, thoughts, and knowledge of self as the participant looks around the compass. The participant may find deep integration of new self esteem beliefs during the bilateral stimulation contributing to a positive mental state of the participant.

After activating the positive mental state and reinforcing the positive mental state, the instructor applies 102c performance enhancement protocols on the participant in the reinforced positive mental state. The performance enhancement protocols invoke 102d positive conditioned responses of the participant through a plurality of self enhancement exercises. The performance enhancement protocols help the participant to identify life goals and life challenges of the participant. The participant chooses a life goal or a life challenge and focuses attention on the life goal or the life challenge during the application of the performance enhancement protocols.

The instructor bilaterally stimulates the participant to simultaneously focus attention on the identified life goals, the identified life challenges, and the predefined geometrical image. The instructor teaches the participant “dual attention” as a part of one of the performance enhancement protocols. The participant focuses partly on the life goals or the life challenges and partly on the predefined geometrical image during the “dual attention” as illustrated in FIGS. 3-5. The process of “dual attention” causes the participant to spontaneously experience subtle but sophisticated solutions, ideas, and inspirations that are accompanied with strong feelings of self assurance, motivation, and confidence as a result of the participant's personal talents revealed from reflecting on the predefined geometric image. The feelings of self assurance, motivation, and confidence are congruent between mind, body, and emotions. The instructor covers different possibilities of application of “dual attention” on the participant by introducing different correlations of the items and the successful past events with the identified life goals and the identified life challenges of the participant. Consciously choosing internal images of self worth and coupling the images with bilateral stimulation results in a reorganized and an integrated sense of self in a short span of time. The focused use of bilateral stimulation with positive images and success memories results in an immediate new positive identity of self, congruence in image, emotion, body, and mind. The participant may also experience a feeling of merger of the participant's prior failures. The participants may sense the participant's prior failures being replaced by the new positive identity of self and self confidence, thereby causing the participant's prior failures to dissolve, resolve, or dissipate completely from the participant's mind, and may even be replaced by a deeper understanding and gratitude for the strength gained from the failure.

By focusing attention simultaneously, the participant is able to establish conditioned responses to the identified life goals and the identified life challenges based on the psychosomatic information and the positive cognitive beliefs on the predefined geometrical image. Self enhancement exercises are then applied on the participant to invoke the positive conditioned responses from the established conditioned responses of the participant. The self enhancement exercises may also be implemented to invoke positive conditioned responses for different aspects of self realization of the participant. The self enhancement exercises may comprise values elicitation exercises.

The values elicitation exercises may invoke values the participant upholds strongly. The values elicitation exercises may begin with the instructor asking the participant questions such as “What is important about life to you?”. The participant may respond by saying “Create peace, cure cancer, fresh drinking water, provide education for all, find harmony with family, save the whales, stop world hunger” or “Building my house, traveling the world, taking a year off”. The instructor may then ask the participant questions based on the response from the participant. For example the instructor may ask “And what is important about creating peace in the world” followed by another question such as “And what is important about creating awareness about tolerance between nations”. The values elicitation exercises may be continued iteratively till the quality of the participant's response begin to reflect deep rooted and meaningful personal desires and the sense of being called. The values elicitation exercises bring about implicit exploration into personal meaning and values clarification of the participants. The values elicitation exercises lead the participants to discover a unique gift the participants may have, to offer to the world at large.

The values elicitation exercises may invoke innermost desires of the participant. The values elicitation exercises may invoke inspirations drawn in by the participant. The inspiration seeking exercises may encourage the participants to explore questions such as “What would you do if you knew you absolutely could not fail?”. The inspiration seeking exercises enable the participants to bypass fear and self-doubt and take advantage of newly enhanced self-esteem and emotional resilience from the compass. The values elicitation exercises may enable the participant to realize the participant's hidden abilities to face future life challenges. During course of the hidden ability realization exercises, the instructor may ask the participants questions such as “If you could improve one thing about your self, what would you choose” and “What is a second thing you would like to improve about yourself?”. The questions asked by the instructor may help the participants to establish goals, dreams, desires, and challenges the participants wish to address confidently.

The instructor then inculcates 102e positive altered personal behavior patterns within the participant by reinforcing the positive conditioned responses on the participant. The participant is motivated to draw on new found internalized images of self worth and self-esteem through the self enhancement exercises taking points of reference from the predefined geometrical image. The instructor teaches the participant to apply the new found internalized images of self worth and self-esteem to the life goals to manage the life challenges with confidence and emotional resilience. The instructor encourages the participant to imagine best or ideal life outcomes in different situations by the application of the new found internalized images of self worth and self-esteem to the life goals. As a result the participant experiences a behavior change in thought, emotion, and actions expressed in the participant's personal relationships and daily choices. The behavior change results in a positive impact on different aspects of the participant's life. The method disclosed herein assists the participant in consciously choosing points of reference to base personal meaning and purpose of the participant's life and participant's personal identity. The method disclosed herein facilitates a deep sense of self assurance and presence of mind to the participant.

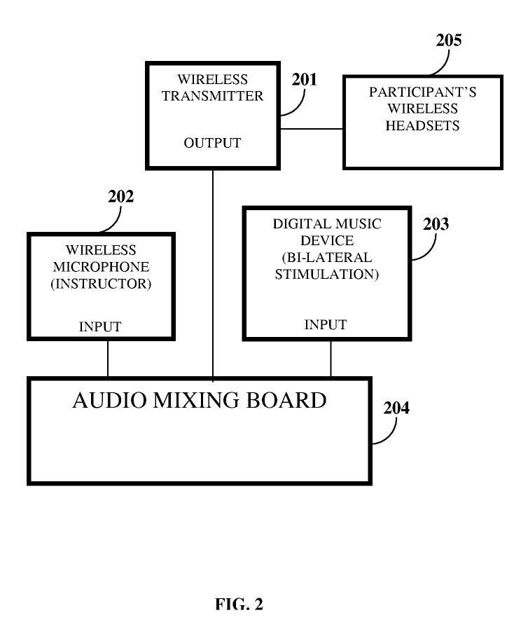

FIG. 2 exemplarily illustrates a system for bilateral stimulation of a participant. The system exemplarily disclosed herein comprises a wireless transmitter 201, a wireless microphone 202, a digital music device 203, and an audio mixing board 204. The system utilizes audio signals for bilateral stimulation. The audio mixing board 204 receives audio inputs from multiple input sources and delivers a single output signal as a combination of the received input signals. The wireless microphone 202 picks up audio signals from the instructor and provides an input feed to the audio mixing board 204. The digital music device 203 provides an audio signal and inputs directly to the audio mixing board 204. The digital music device 203 may be one of a digital music player, a compact disc player, a magnetic tape player, etc. The wireless transmitter 201 receives the combined output signal from the audio mixing board 204 and transmits the combined signal to the participant's wireless headset 205.

The system disclosed herein may be used for multiple participants in a group environment. The wireless transmitter 201 may transmit the combined audio signal from the wireless microphone 202 and the digital music device 203 to a number of participants provided with separate wireless headsets 205.

In a group setting, the instructor instructs the participants through the wireless microphone 202. The audio signals from the wireless microphone 202 and digital music device 203 are combined and channeled through the audio mixing board 204 to the participants. The participants then listen to the instructor's voice through the wireless headsets 205 along with the music played by the digital music device 203. Exemplarily, the participants listen to the instructor's voice simultaneously through from both ears, with the music from the digital music device 203 panning left to right.

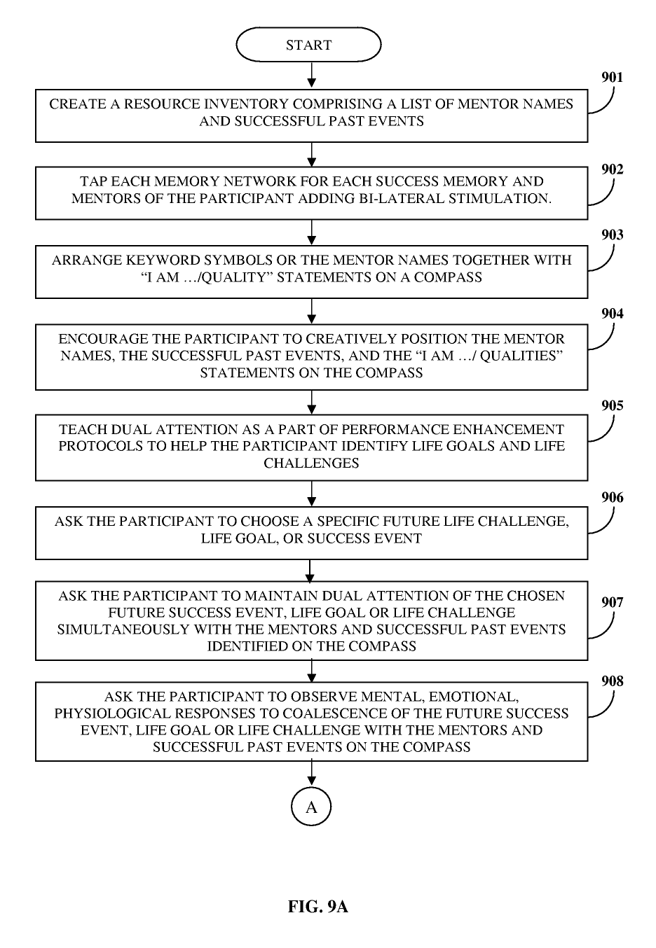

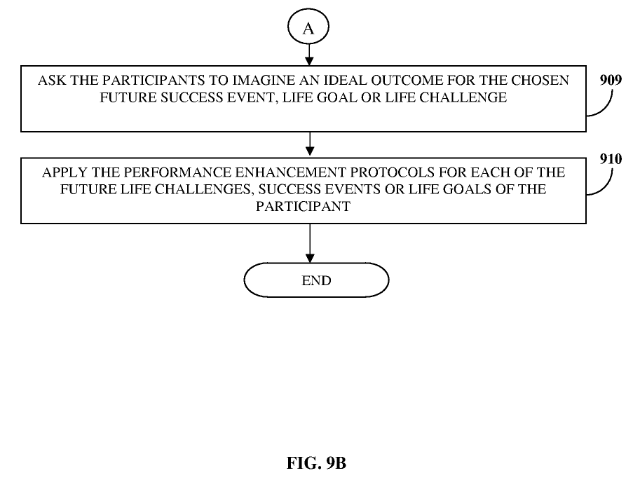

Consider an example of the method disclosed herein as illustrated in FIGS. 9A-9B, where the participant undergoes bilateral stimulation combined with the performance enhancement protocols. The participant creates 901 a resource inventory comprising a list of mentor names or support persons. The participant further creates a list of successful past events. Each memory network for each success memory and mentors is tapped 902 and reprocessed one at a time adding bi-lateral stimulation. The bilateral stimulation may include specific instructions given by the instructor to focus the participant's attention to enable the participant to imagine the image of mentors or the successful past events. The instructor then encourages the participant to notice the emotional responses corresponding to the imagined image. The instructor may provide an audio or a video stimuli suggesting the instructions such as “What sensation in your body do you associate with the emotion and the image of the person or event”. The instructor may then ask the participant to continue to focus attention on the imagined image, emotional responses, and body sensations associated with the mentors or the successful past events. After a predefined period of time, for example, time ranging from 30 seconds to 3 minutes, the instructor may then ask the participant questions such as “As you notice the changes in your emotions, your body, what words about yourself as a person go with these feelings?” through an auditory, tactile, a visual stimuli or any combination thereof. The instructor then requests the participant to complete the positive cognitive beliefs such as “I am . . . /Quality” statement as illustrated in FIG. 3.

The result of such a bilateral stimulation is a new encompassing feeling and belief associated with the successful past events or the mentors reflected in the “I Am . . . /Quality” statement. The instructor may then ask the participant questions such as “What sensation in your body goes with this new ‘I am . . . /Quality’ statement?” through an auditory, tactile, or a visual stimuli. The instructor may ask the participant to focus attention on the body sensations associated with the “I am . . . /Quality” statement. In a second embodiment, the instructor may ask the participant to focus attention first on a memory picture in the participant's mind of the mentors or the successful past events. The instructor may then invoke the emotional responses stimulated by the memory picture and the body sensation associated with both the emotional responses and the memory picture of the mentors or the successful past events in the participant through bilateral stimulation. Maintaining attention on each of the items of focus results in a new found positive cognitive belief and understanding within a short span of time. The instructor may then ask the participant to write the new found positive cognitive belief and complete the “I Am . . . /Quality” in the corresponding spot to the memory keyword as illustrated in FIG. 4. The tapping and reprocessing of the memory networks may be implemented iteratively for each of the mentors in the resource inventory as illustrated in FIG. 3 and each of the successful past events as illustrated in FIG. 4.

The instructor then asks the participant to arrange 903 the memory keyword or the mentor names together with the associated positive cognitive beliefs or the “I Am . . . /Quality” statement at a random position on a predefined geometrical image such as the compass as per the preferences of the participant as illustrated in FIG. 4. The instructor then encourages 904 the participant to be creative with the positioning of the mentor names, the successful past events, and the associated positive cognitive beliefs stated in the “I am . . . /Qualities” statement on the compass. The participant may then correlate the mentor names, the successful past events, and the associated positive cognitive beliefs positioned on the compass. The bi-lateral stimulation is continued and the instructor may instruct and ask the participant questions such as “Simply allow your eyes to move around your compass, notice your emotions, notice your body, notice your thoughts, what words about you as a person go with how you feel as you look at your personal Compass, I am . . . ?”. The correlation results in a deep integration of the new self-esteem beliefs.

The instructor teaches 905 the participant “dual attention” as a part of the performance enhancement protocols to help the participant to find inner potential and clarity for achieving life goals, life purpose and personal desires from the new self esteem beliefs. The instructor then teaches the participant means to apply the new found self-esteem and newly revitalized successful past events to future events, the life goals, and life challenges. The instructor then asks 906 the participant to choose a specific future life challenge, life goal, or success event among the identified life goals, identified life purposes and desires resulting in increased self confidence and motivation to achieve personal desires and goals. The instructor may then ask the participant questions such as “who on your compass, and what success memory could assist you, or who might you model your response after, what success memory could inform you in achieving the most ideal outcome”. After the participant chooses the mentors and the success events from the compass, the instructor asks 907 the participant to hold and maintain dual attention of the chosen future success event, life goal or life challenge simultaneously with the mentors and successful past events identified from the compass. The bilateral stimulation is applied while maintaining the “dual attention”. The “dual attention” enables the participant to establish positive conditioned responses to the future success event, life goal and life challenge based on the previously identified positive conditioned responses derived from the mentors and the success events on the predefined geometric image.

The instructor then asks 908 the participant to observe mental, emotional, physiological responses to coalescence of the future success event with the mentors and the success memories. The instructor then asks 909 the participants to imagine an ideal outcome for the chosen future success event, life goal or life challenge. The participant may then notice the successful past events and mentors from the participant's compass who may reconfirm the participant's ability to achieve the ideal outcome. The instructor then applies 910 performance enhancement protocols for each of the future life challenges, success events or life goals of the participant.

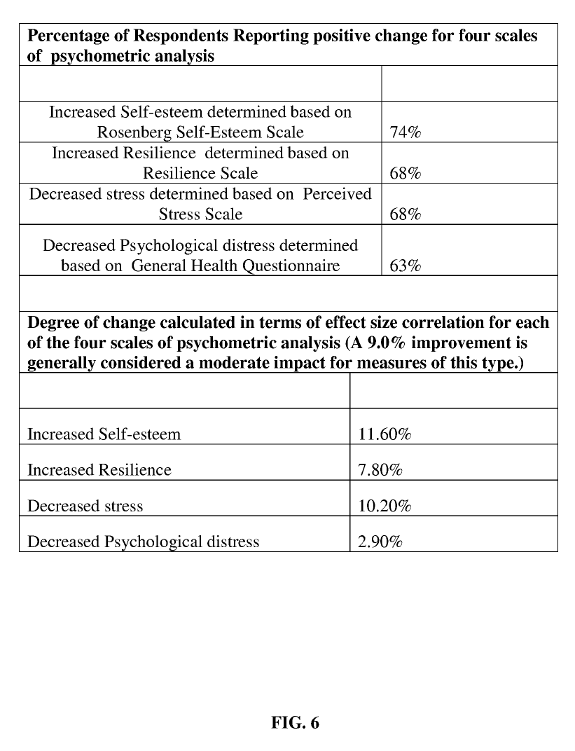

Consider an example of test results obtained by applying the process of inculcating the positive altered behavioral patterns through the bilateral stimulation and performance enhancement protocols on a group of participants is as illustrated in FIG. 6. Each participant responds to four different scales of psychometric analysis twice. The participants respond to the psychometric analysis once before undergoing the process of inculcating positive altered behavioral patterns using the bilateral stimulation and once after the process of inculcating positive altered behavioral patterns using the bilateral stimulation. The four different scales of psychometric analysis comprise a “Perceived Stress Scale” for determining stress in individuals, a “General Health Questionnaire” as a screening instrument for psychological distress, a “Resilience Scale” for assessing participants' self-perception to handle the life challenges and a “Rosenberg Self-Esteem Scale” for determining participants' level of self esteem. The “Perceived Stress Scale” scale is a general measure of current levels of perceived stress in an individual. The “Perceived Stress Scale” is used in psychological research on stress in adults and adolescents and is considered as a global measure of perceived stress. The “General Health Questionnaire” is a 12 item general health questionnaire (GHQ-12) widely used as a screening instrument for psychological distress including anxiety and depression, social dysfunction, and loss of confidence. The “Resilience Scale” assesses the participants' self perception of capability of handling current problems or life challenges. The “Rosenberg Self-Esteem Scale” is used for determining participants' level of self esteem in studies involving both adults and adolescents.

Correlations among variables such as the perceived stress levels, self esteem, and emotional resilience are made. The self esteem is positively correlated with the emotional resilience and negatively correlated with perceived stress levels and psychological distress. The emotional resilience is negatively correlated with both the perceived stress levels and the psychological distress. The perceived stress levels are correlated with psychological distress. Increase in effect of positively correlated variables corresponds to a decrease in effect of the negatively correlated variables.

The effects of the bilateral stimulation are assessed by “t-tests”. The “t-tests” provide a comparison means for each of the four different scales of psychometric analysis before and after the bilateral stimulation. After the process of inculcating the positive altered behavioral patterns through the bilateral stimulation, the participants showed enhanced self-esteem and emotional resilience. Additionally, perceived stress levels and psychological distress of the participants are reduced. The test results validate the efficacy of the process of inculcating the positive altered behavioral patterns through bilateral stimulation used on the participants. The percentage of participants reporting an enhancement in the self esteem, the emotional resilience, and reduction stress levels due to the bilateral stimulation is calculated for each of the four different scales of psychometric analysis. Based on the calculation, 74% of the participants reported increased self-esteem, 68% of the participants reported increased emotional resilience, 68% of the participants reported decreased stress, and 63% of the participants reported decreased distress. The calculated percentage change in the self esteem, the emotional resilience, and reduction stress levels of the participants is calculated in terms of effect size correlation on each of the four different scales of psychometric analysis. Typically, effect size correlation indicating about 6% to 9.0% improvement in the variables is considered as a moderate impact of the method disclosed herein. The effect size correlation indicated an 11.6% improvement in the self esteem of the participants and a 7.8% improvement in the emotional resilience of the participants. The effect size correlation also indicated a 10.2% reduction in the perceived stress levels and a 2.9% reduction of the psychological distress.

Consider an example of test results obtained by applying the process of inculcating the positive altered behavioral patterns through the bilateral stimulation combined with performance enhancement protocols on a group of participants as illustrated in FIG. 7. The percentage of participants reporting an enhancement in the self esteem, the emotional resilience, and reduction stress levels due the bilateral stimulation combined with the performance enhancement protocols is calculated for each of the four different scales of psychometric analysis. Based on the calculation, 80% of the participants reported increased self-esteem, 87% of the participants reported increased emotional resilience, 73% of the participants reported decreased stress, and 100% of the participants reported decreased distress. The calculated percentage change in the self esteem, the emotional resilience, and reduction stress levels of the participants is calculated in terms of predetermined correlation methods such as effect size correlation on each of the four different scales of psychometric analysis. The effect size correlation indicated a 22.1% improvement in the self esteem of the participants and a 22.1% improvement in the emotional resilience of the participants. The effect size correlation also indicated a 14.4% reduction in the perceived stress levels and a 53.3% reduction of the psychological distress.

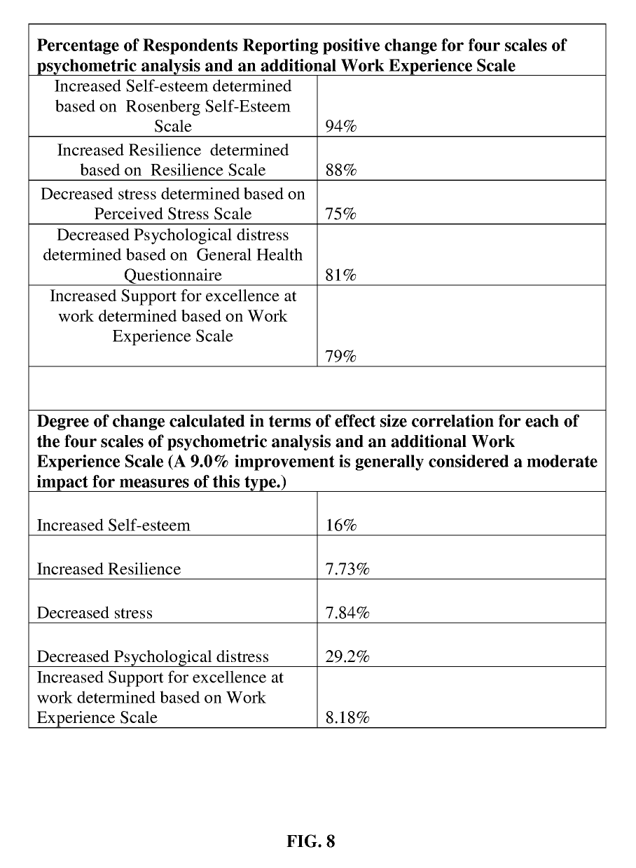

Consider an example of test results obtained by applying the process of inculcating the positive altered behavioral patterns through the bilateral stimulation combined with the performance enhancement protocols on a group of participants incorporating work experience of the participants, is as illustrated in FIG. 8. Each participant responds to a “Work experience” scale (M. Buckingham and C. Coffman, 1999), in addition to the four different scales of psychometric analysis. The “Work experience” scale is a 12 item scale based on interviews conducted on participants over an extended period of time to measure the participants' perception about the participants' work environment. The “Work experience” scale may determine if the participants' work environment was supportive and conducive to achieve excellence. The “Cronbach's alpha” is a statistic for measuring reliability of a psychometric instrument or a scale of psychometric analysis. Based on the interviews conducted on participants over the extended period of time, the “Cronbach's alpha” was 0.83 for the “Work experience” scale, indicating high reliability and unidimensionality of the “Work experience” scale.

The percentage of participants reporting an enhancement in the self esteem, the emotional resilience, and reduction stress levels due the bilateral stimulation combined with the performance enhancement protocols is calculated for each of the four different scales of psychometric analysis. Based on the calculation, 94% of the participants reported increased self-esteem, 88% of the participants reported increased emotional resilience, 75% of the participants reported decreased stress, 81% of the participants reported decreased distress, and 79% of the participants reported increased sense of possibility of achieving excellence at the participants' work environment. The calculated percentage change in the self esteem, the emotional resilience, and reduction stress levels of the participants is calculated in terms of predetermined correlation methods such as effect size correlation on each of the four different scales of psychometric analysis. The effect size correlation indicated a 16% improvement in the self esteem of the participants and a 7.73% improvement in the emotional resilience of the participants. The effect size correlation also indicated a 7.84% reduction in the perceived stress levels, a 29.2% reduction of the psychological distress, and an 8.18% improvement in the participants' perception of support for achieving excellence at work.

The effectiveness of the process of inculcating the positive altered behavioral patterns through the bilateral stimulation combined with the performance enhancement protocols is demonstrated in the test results as illustrated in FIGS. 6-8. The group of participants ranged from about 18 people to 38 people. The participants respond to scales of psychometric analysis used in research to measure self-esteem, a sense of resiliency to stress and change, degree of stress in participants' life, and the psychological distress. The participants are also assessed for changes in perceived support for work excellence. The test results are statistically consistent and reliable to be implemented for practical application. The test results indicate improvement in the self-esteem, the emotional resilience and the perceived support for excellence at work of the participants. The test results also indicate the decrease in the perceived stress levels and psychological distress of the participants.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of inculcating positive altered personal behavioral patterns in a participant, comprising the steps of:
creating a resource inventory of items associated with said participant, wherein said association of the participant with said items induces a state of well being in the participant;
leading the participant through a plurality of bilateral stimulation processes by an instructor, comprising the steps of:
activating a positive mental state of the participant by bilateral stimulation of conscious and unconscious memory networks associated with the items of said resource inventory, wherein said conscious and unconscious memory networks store psychosomatic information comprising one or more of thoughts, images, audio, olfactory memories, emotions, and somatic sensations of the participant associated with the items of the resource inventory;
reinforcing said positive mental state of the participant through said bilateral stimulation;
applying performance enhancement protocols by said instructor on the participant in said reinforced positive mental state, comprising the steps of:
invoking positive conditioned responses of the participant through a plurality of self enhancement exercises; and
inculcating said positive altered personal behavior patterns in the participant by reinforcing said positive conditioned responses;
whereby the bilateral stimulation combined with said performance enhancement protocols inculcate the positive altered personal behavior patterns in the participant.

2. The method of claim 1, wherein the items in the resource inventory comprise people, spiritual deities, events, places, animals, and objects.

3. The method of claim 1, wherein the bilateral stimulation comprises applying one or more of stimuli to the participant, wherein spatial position of said applied stimuli changes in a predetermined manner, wherein the applied stimuli is one or more of auditory stimuli, tactile stimuli, and visual stimuli.

4. The method of claim 3, wherein said change in said spatial position of the applied stimuli activates right cerebral hemisphere and left cerebral hemisphere of the participant.

5. The method of claim 1, wherein the bilateral stimulation involves physical activity of the participant, wherein the participant uses left body portion and right body portion of the participant alternately to accomplish said physical activity.

6. The method of claim 1, identifying and creating a list of past events by the participant, wherein the participant experienced a state of success during said past events.

7. The method of claim 6, wherein the participant creates associations of the items and said successful past events with a plurality of positive cognitive beliefs, wherein the participant is led through the bilateral stimulation during said creation of said associations.

8. The method of claim 7, wherein the participant records psychosomatic information and said associated positive cognitive beliefs with each of the items and the successful past events.

9. The method of claim 8, wherein the participant arranges the items of the resource inventory, the successful past events, and the associated positive cognitive beliefs on a predefined geometrical image in a spatial pattern determined by the participant.

10. The method of claim 9, further comprising a step of identifying life goals and life challenges by the participant, wherein the participant simultaneously focuses attention on said identified life goals, said identified life challenges, and said predefined geometrical image.

11. The method of claim 10, wherein said focusing of said attention of the participant causes the participant to establish conditioned responses to the identified life goals and the identified life challenges based on psychosomatic information and positive cognitive beliefs.

12. The method of claim 11, wherein the self enhancement exercises are applied on the participant to invoke positive conditioned responses from said established conditioned responses of the participant.

13. The method of claim 1, wherein said self enhancement exercises comprise values elicitation exercises.
